(19) United States
(12) Patent Application Publication
(10) Pub. No.: US 2019/0275971 A1
(43) Pub. Date: Sep. 12, 2019

(54) APPARATUS AND METHOD THAT PERFORM SENSING TUBE DIAGNOSTICS

(71) Applicant: GM GLOBAL TECHNOLOGY OPERATIONS LLC, Detroit, MI (US)

(72) Inventor: Christopher A. Stanek, Lake Orion, MI (US)

(21) Appl. No.: 15/916,856

(22) Filed: Mar. 9, 2018

(51) Int. Cl. B60R 21/0136; G01L 9/00; G01L 27/00

(52) U.S. Cl. CPC B60R 21/0136; B60R 19/483; G01L 27/007; G01L 9/0026

(57) ABSTRACT

A sensing tube diagnostic method and apparatus are provided. The apparatus includes: a sensor configured to transmit an electrical signal at a first part of a sensing tube and receive the transmitted signal at a second part of the sensing tube and a controller configured to determine a difference between the transmitted electrical signal and the received signal, and diagnose a condition of the sensing tube based on the determined difference.

### INTRODUCTION

Apparatuses and methods consistent with exemplary embodiments relate to sensing tube diagnostics. More particularly, apparatuses and methods consistent with exemplary embodiments relate to detecting a defect in a sensing tube.

### SUMMARY

One or more exemplary embodiments provide a method and an apparatus that detect the condition or a presence of defect in a sensing tube. More particularly, one or more exemplary embodiments provide a method and an apparatus that transmit an electronic signal through a first part of a conductive sensing tube and determine a defect in the sensing tube by receiving and analyzing the transmitted signal at a second part of the sensing tube.

According to an aspect of another exemplary embodiment, a sensing tube diagnostic apparatus is provided. The apparatus includes a sensing tube comprising a conductive material, a sensor configured to transmit an electrical signal at a first part of the sensing tube and receive the transmitted signal at a second part of the sensing tube, and a controller configured to determine a difference between the transmitted electrical signal and the received signal, and diagnose a condition of the sensing tube based on the determined difference.

The apparatus may also include an energy absorber disposed between a front bumper cover and a front bumper reinforcement. The sensing tube may be disposed between the energy absorber and the front bumper reinforcement.

The sensor may include a first sensor connected the first part of the sensing tube and a second sensor connected at the second part of the sensing tube.

The first sensor may include a first conductive protrusion contacting the first part of the sensing tube and the second sensor may include a second conductive protrusion contacting the second part of the sensing tube.

The first part of the sensing tube may be a first end of the sensing tube, and the second part of the sensing tube may be a second end of the sensing tube.

The sensor may include a first conductive protrusion contacting the first part of the sensing tube and a second conductive protrusion contacting the second part of the sensing tube.

The sensing tube may further include a conductive silicon material or a silicone tube printed with conductive ink. The electrical signal may include a diagnostic pulse, a half sine or square wave form generated at a specific interval, or a series of square wave pulses.

The controller may be configured to determine a difference in at least one from among a voltage, a current, and a frequency, of the transmitted electrical signal and the received signal.

The sensor may be configured to detect a pressure change in the sensing tube, and the controller may be configured to control to deploy an airbag based on a change in pressure detected by the sensor.

According to an aspect of an exemplary embodiment, a sensing tube diagnostic method is provided. The method includes transmitting an electrical signal at a first part of a sensing tube including a conductive material, receiving the transmitted electrical signal at a second part of the sensing tube, determining differences between the transmitted electrical signal and the received signal, and diagnosing a condition of the sensing tube based on the determined differences.

The transmitting the electrical signal at the first part of the sensing tube may include transmitting the electrical signal by a first sensor connected to the first part of the sensing tube.

The receiving the transmitted electrical signal at the second part of the sensing tube may include receiving the transmitted electrical signal by a second sensor connected to the second part of the sensing tube.

The first part of the sensing tube may be a first end of the sensing tube, and the second part of the sensing tube may be a second end of the sensing tube.

The electrical signal may be a diagnostic pulse, a half sine or square wave form generated at a specific interval, or a series of square wave pulses.

The determining differences between the transmitted electrical signal and the received signal may include determining a difference in at least one from among a voltage, a current, and a frequency, of the transmitted electrical signal and the received signal.

The diagnosing the condition of the sensing tube based on the determined differences includes diagnosing a defect in the sensing tube based on the determined difference.

The diagnosing the defect in the sensing tube based on the determined difference may include diagnosing a size of the defect.

The defect may be at least one from among a puncture in the sensing tube, a hole in the sensing tube, a severed sensing tube, a crack in the sensing tube and a degradation in wall of the sensing tube.

According to an aspect of another exemplary embodiment, a sensing tube diagnostic apparatus is provided. The apparatus includes: a sensor configured to transmit an electrical signal at a first part of a sensing tube and receive the transmitted signal at a second part of the sensing tube, and a controller configured to determine a difference between the transmitted electrical signal and the received signal, and diagnose a condition of the sensing tube based on the determined difference.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of a sensing tube diagnostic apparatus according to an exemplary embodiment;

FIG. 2 shows a flowchart for a sensing tube diagnostic method according to an exemplary embodiment;

FIGS. 3A and 3B show illustrations of a sensing tube and diagnostic sensors according to an aspect of an exemplary embodiment; and

FIGS. 4A and 4B show illustrations of an example sensing tube configuration according to an aspect of an exemplary embodiment.

### DETAILED DESCRIPTION OF EXEMPLARY EMBODIMENTS

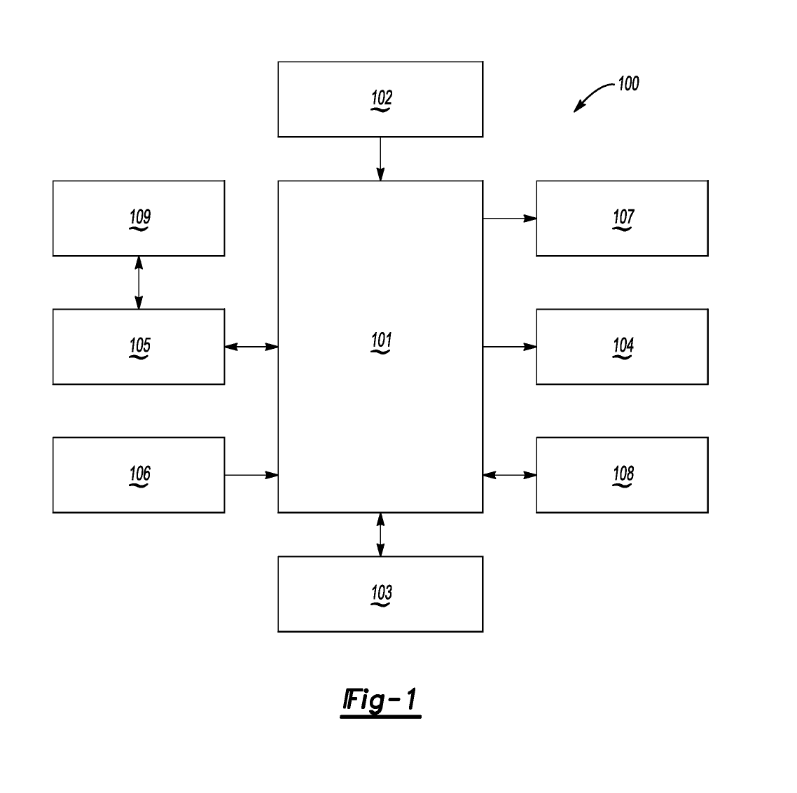

A sensing tube diagnostic apparatus and method will now be described in detail with reference to FIGS. 1-4B of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Vehicles often include a number of different occupant protection systems. Examples of occupant protection systems include seat belts, air bags, etc. that protect occupants of a vehicle. Moreover, air bags may be provided at one or more locations within a vehicle. Vehicles may also include front and rear bumper reinforcements. The front and rear bumper reinforcements of a vehicle are attached to a chassis of the vehicle. The front and rear bumper reinforcements may be covered from external view by bumper covers, which are also called fascia. Energy absorbing material, such as energy absorbing foam, may be disposed between a bumper reinforcement and a bumper cover.

The vehicle bumpers are usually the first point of contact in the case of a collision. Thus, sensors are placed in the bumper area to detect the occurrence of a collision or impact to the bumper. For example, sensors and/or a sensing tube may be placed in energy absorbing foam and/or sandwiched between a bumper reinforcement and a bumper cover. The sensors and/or sensing tube detect the collision or impact and this detection may be used to trigger vehicle components such as an interior airbag or an exterior pedestrian airbag. For proper operation of sensors and/or a sensing tube to properly trigger certain vehicle components, a sensing tube diagnostic needs to be performed to ensure that defects are not present in the sensing tube and/or sensing tube sensors.

FIG. 1 shows a block diagram of a sensing tube diagnostic apparatus 100 according to an exemplary embodiment. As shown in FIG. 1, the sensing tube diagnostic apparatus 100, according to an exemplary embodiment, includes a controller 101, a power supply 102, a storage 103, an output 104, a sensing tube sensor 105, a user input 106, protection system actuator 107, a communication device 108 and a sensing tube 109. However, the sensing tube diagnostic apparatus 100 is not limited to the aforementioned configuration and may be configured to include additional elements and/or omit one or more of the aforementioned elements. The sensing tube diagnostic apparatus 100 may be implemented as part of a vehicle, as a standalone component, as a hybrid between an on vehicle and off vehicle device, or in another computing device.

The controller 101 controls the overall operation and function of the sensing tube diagnostic apparatus 100. The controller 101 may control one or more of a storage 103, an output 104, a sensing tube sensor 105, a user input 106, a protection system actuator 107, a communication device 108, and a sensing tube 109 of the sensing tube diagnostic apparatus 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the sensing tube sensor 105, the user input 106, the protection system actuator 107, the communication device 108, and the sensing tube 109 of the sensing tube diagnostic apparatus 100. The information may be sent and received via a bus or network, or may be directly read or written to/from one or more of the storage 103, the output 104, the user input 106, the protection system actuator 107, and the communication device 108 of the sensing tube diagnostic apparatus 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the sensing tube sensor 105, the user input 106, the protection system actuator 107, and the communication device 108, of the sensing tube diagnostic apparatus 100. The power supply 102 may include one or more from among a battery, an outlet, a capacitor, a solar energy cell, a generator, a wind energy device, an alternator, etc.

The storage 103 is configured for storing information and retrieving information used by the sensing tube diagnostic apparatus 100. The storage 103 may be controlled by the controller 101 to store and retrieve information received from the protection system actuator 107 or the sensing tube sensor 105. For example, the storage may store information provided by the sensing tube sensor 105 such as sensing tube pressure information, sensing tube condition information, or electrical signal information (e.g., transmitted electrical signal and/or received electrical signal). Electrical signal information may include a voltage, a current, and/or a frequency, of the transmitted electrical signal and the received signal. The sensing tube condition information may be information indicating a puncture in the sensing tube, a hole in the sensing tube, a crack in the sensing tube, a severed sensing tube, a degradation in wall of the sensing tube, a defect in the sensing tube or a size of the defect. In another example, the storage may store information provided by the protection system actuator 107 such as actuator status information. The storage 103 may also include the computer instructions configured to be executed by a processor to perform the functions of the sensing tube diagnostic apparatus 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the sensing tube diagnostic apparatus 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an indicator light, etc.

The output 104 may output notification including one or more from among an audible notification, a light notification, and a display notification. The notification may include information notifying of the sensing tube condition information or protection system fault caused by a sensing tube condition.

The sensing tube sensor 105 may be configured to output or generate an electronic signal to a first part of the sensing tube 109 and receive the outputted electronic signal at a second part of the sensing tube 109. The sensing tube sensor 105 may include a plurality of separate sensors, each of the plurality of sensors configured to perform the outputting of the electronic signal and/or the receiving of the outputted electronic signal. The sensing tube sensor 105 may output and receive the electronic signal at conductive protrusions extending from the sensing tube 109 or conductive plates on the sensing tube 109. The electronic signal output or generated by the sensing tube sensor 105 may be a diagnostic pulse, a half sine or square wave form generated at a specific interval, or a series of square wave pulses generating a digital signal.

The user input 106 is configured to provide information and commands to the sensing tube diagnostic apparatus 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104. The user input 106 may also be configured to receive a user input to activate or deactivate the sensing tube diagnostic apparatus 100. For example, the setting to turn the protection system on or off may be selected by an operator via user input 106.

The protection system actuator 107 may include one or more from among a plurality of actuators configured to actuate protection system components. For example, the protection system actuator 107 may actuate or be one or more form among an airbag inflator, a seatbelt tensioner, an exterior pedestrian protection airbag inflator, an interior airbag inflator, a hood lift actuator, a door locking/unlocking mechanism, etc. The protection system actuator 107 may also include an actuator to change (e.g., increase) pressure within the sensing tube 109. The actuator to change (e.g., increase) pressure within the sensing tube 109 may be, for example, a linear actuator or a piezoelectric actuator.

A piezoelectric actuator may be embedded within the walls of the sensing tube, and may be a ceramic tube actuator, a wire (e.g., nitinol wire) actuator, or another suitable type of tube actuator. A linear actuator may extend into a side of the sensing tube and cause a pressure increase within the sensing tube, or may be located within the recess in the back side of the energy absorber.

The communication device 108 may be used by sensing tube diagnostic apparatus 100 to communicate with various types of external apparatuses according to various communication methods. The communication device 108 may be used to send/receive various information such as information on the sensing tube condition and/or protection system actuation information to/from the controller 101 of the sensing tube diagnostic apparatus 100.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, WI-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

The sensing tube 109 may comprise a conductive material such as conductive silicon and may also be flexible. According to various examples, the sensing tube may be a conductive tube or a silicone tube printed with conductive ink. The sensing tube 109 The sensing tube or the sensing tube sensor 105 may include one or more vent holes such that pressure within the sensing tube can approach or reach ambient pressure. The sensing tube 109 may include a first conductive protrusion contacting the first part of the sensing tube and a second conductive protrusion contacting the second part of the sensing tube.

According to an exemplary embodiment, the controller 101 of the sensing tube diagnostic apparatus 100 may be configured to determine a difference between the transmitted electrical signal and the received signal, and diagnose a condition of the sensing tube based on the determined difference.

The controller 101 may be sensing diagnostic module of a vehicle. The controller 101 may include a diagnostic module determines whether a defect is present with the sensing tube 109 or a condition of the sensing tube 109 based on an electrical signal. For example, the controller 101 may determine a size of the defect or determine a type of the defect as being one from among a puncture in the sensing tube, a hole in the sensing tube, a severed sensing tube, a crack in the sensing tube and a degradation in wall of the sensing tube. In another example, a total failure may be detected by a total loss of signal/resistance of the signal and a partial failure or tear may be detected by a change in resistance of the signal.

The controller 101 of the sensing tube diagnostic apparatus 100 may be configured to the controller configured to determine a difference in at least one from among a voltage, a current, and a frequency, of the transmitted electrical signal and the received signal. In addition, the controller 101 of the sensing tube diagnostic apparatus 100 may be configured to control to deploy an airbag based on a change in pressure detected by the sensor.

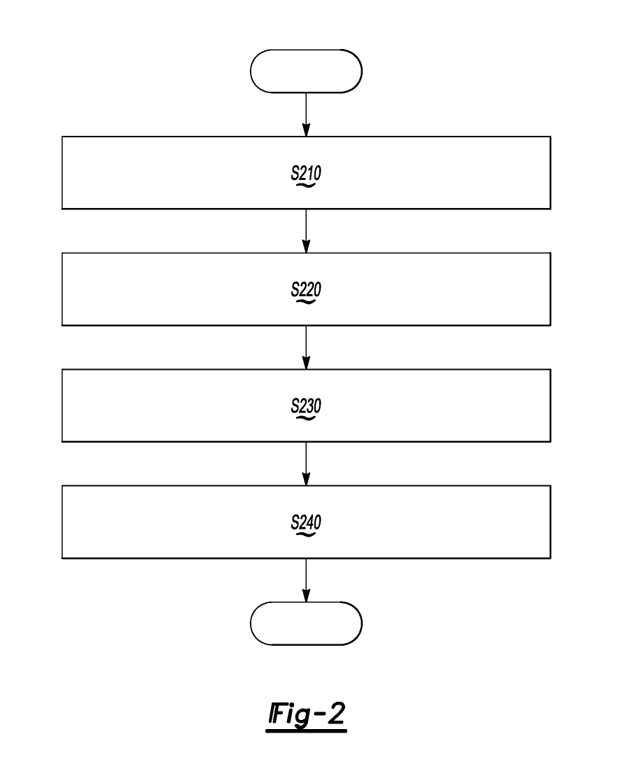

FIG. 2 shows a flowchart for a sensing tube diagnostic method according to an exemplary embodiment. The method of FIG. 2 may be performed by the sensing tube diagnostic apparatus 100 or may be encoded into a computer readable medium as instructions that are executable by a computer to perform the method.

Referring to FIG. 2, an electrical signal is sent or transmitted at a first part of a sensing tube in operation S210. In particular, an electrical signal is sent by a sensor from a first end of a flexible conductive silicon sensing tube via a first conductive protrusion at the first end of the sensing tube. The transmitted electrical signal may be a diagnostic pulse.

In operation 220, the transmitted electrical signal is received by a sensor at a second part of the sensing tube. In particular, the transmitted electrical signal may be received via a second conductive protrusion at the second end of the sensing tube.

The received signal is then analyzed in operation 230. Specifically, differences between the transmitted electrical signal and received signal are determined by comparing the two signals or information about the two signals. Based on the determined differences, the condition of the sensing tube is diagnosed in operation S240.

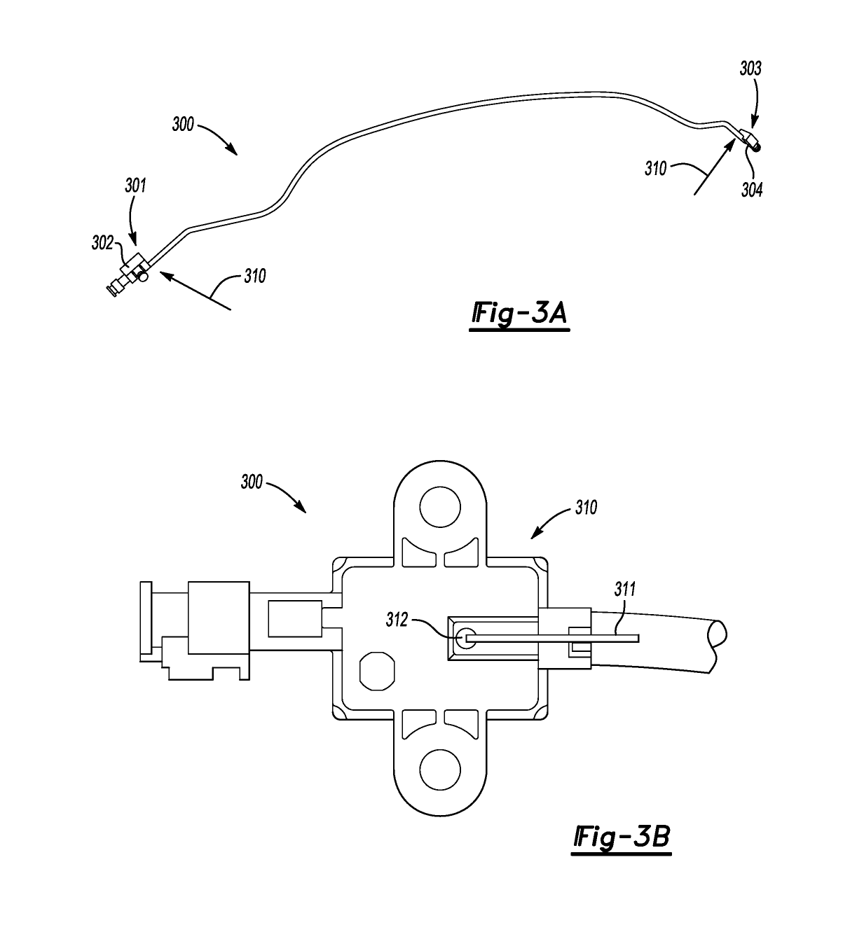

FIGS. 3A and 3B show illustrations of a sensing tube and diagnostic sensors according to an aspect of an exemplary embodiment.

Referring to FIG. 3A, a sensing tube 300 may be made of conductive silicon material. A first sensor 302 may be placed or may be configured to transmit or receive an electrical signal at a first end 301 of the sensing tube 300. A second sensor 304 may be placed or may be configured to transmit or receive an electrical signal at a second end 303 of the sensing tube 300. The example shown in FIG. 3A is not limiting and one sensor may be configured to transmit or receive an electrical signal at a first end 301 or a second end 303 of sensing tube 300.

Referring to FIG. 3B, an illustration 310 showing an example sensor 312 disposed at one end of the sensing tube 300 is shown. As shown in FIG. 3B, protrusion 311 extends from the sensing tube 300. The protrusion 311 configured to receive/transmit an electrical signal sent by sensor 312.

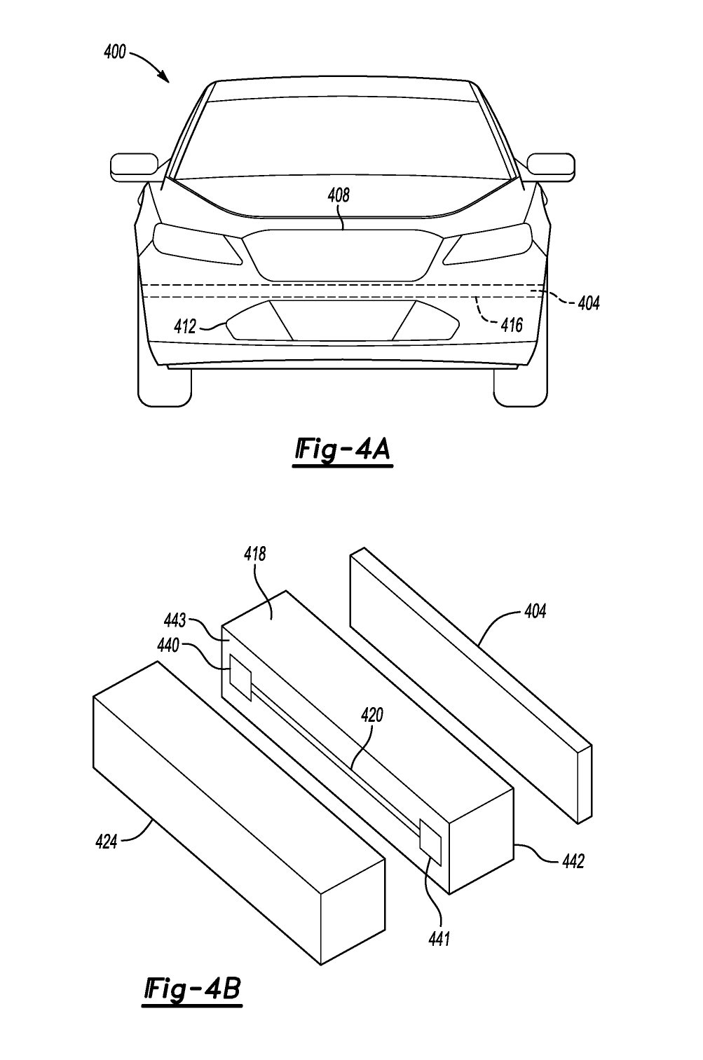

FIGS. 4A and 4B show illustrations of an example sensing tube configuration according to an aspect of an exemplary embodiment. Referring to FIG. 4A, a front view of an example vehicle 400 with a sensing tube of a protection system 416. The vehicle includes a front bumper fascia 404, an upper grille 408, and a lower grille 412. However, the upper grille 408 and/or the lower grille 412 may be omitted. The sensing tube of a protection system 416 is located behind the front bumper fascia 404 and may be between the upper grille 408 and the lower grille 412 of the vehicle 400

Referring to FIG. 4B, an example exploded view of a sensing tube of a protection system 416 is shown. The energy absorber 418 has a front side 442 and a back side 443. The front side 442 faces and may be mounted to (the inner surface of) the front bumper fascia 404. The back side 443 faces and may be mounted to the front bumper reinforcement 424.

The sensing tube 420 may be located in a recess in the back side 243 of the energy absorber 418 such that a portion of the sensing tube 420 is exposed to the front bumper reinforcement 424. The first and second sensing tube sensors 440 and 441 may also be located in the recess in the back side 443 of the energy absorber 418. A collision with the front bumper fascia 404 compresses the energy absorber 418 and the sensing tube 420 against the front bumper reinforcement 424. Therefore, an internal volume of the sensing tube 420 decreases and pressure within the sensing tube 420 increases when a collision occurs.

The pressure increase may vary based upon what collides with the front bumper fascia 404. For example, a collision with a pedestrian may generate at least a 25 millibar pressure increase. A collision with a vehicle or another type of object, however, may generate a larger pressure increase.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A sensing tube diagnostic apparatus, comprising:
a sensing tube comprising a conductive material;
a sensor configured to transmit an electrical signal at a first part of the sensing tube and receive the transmitted signal at a second part of the sensing tube; and
a controller configured to determine a difference between the transmitted electrical signal and the received signal, and diagnose a condition of the sensing tube based on the determined difference.

2. The apparatus of claim 1, further comprising:
an energy absorber disposed between a front bumper cover and a front bumper reinforcement,
wherein the sensing tube is disposed between the energy absorber and the front bumper reinforcement.

3. The apparatus of claim 1, wherein the sensor comprises a first sensor connected the first part of the sensing tube and a second sensor connected at the second part of the sensing tube.

4. The apparatus of claim 3, wherein the first sensor comprises a first conductive protrusion contacting the first part of the sensing tube and the second sensor comprises a second conductive protrusion contacting the second part of the sensing tube.

5. The apparatus of claim 4, wherein the first part of the sensing tube comprises a first end of the sensing tube, and the second part of the sensing tube comprises a second end of the sensing tube.

6. The apparatus of claim 1, wherein the sensor comprises a first conductive protrusion contacting the first part of the sensing tube and a second conductive protrusion contacting the second part of the sensing tube.

7. The apparatus of claim 1, wherein the sensing tube further comprises a conductive silicon or a silicone tube printed with conductive ink.

8. The apparatus of claim 1, wherein the electrical signal comprises a diagnostic pulse, a half sine or square wave form generated at a specific interval, or a series of square wave pulses.

9. The apparatus of claim 1, wherein the controller configured to determine a difference in at least one from among a voltage, a current, and a frequency, of the transmitted electrical signal and the received signal.

10. The apparatus of claim 1, wherein the sensor is configured to detect a pressure change in the sensing tube,
wherein the controller is configured to control to deploy an airbag based on a change in pressure detected by the sensor.

11. A method for performing a sensing tube diagnostic, the method comprising:
transmitting an electrical signal at a first part of a sensing tube including a conductive material;
receiving the transmitted electrical signal at a second part of the sensing tube;
determining differences between the transmitted electrical signal and the received signal; and
diagnosing a condition of the sensing tube based on the determined differences.

12. The method of claim 11, wherein the transmitting the electrical signal at the first part of the sensing tube comprises transmitting the electrical signal by a first sensor connected to the first part of the sensing tube.

13. The method of claim 12, wherein the receiving the transmitted electrical signal at the second part of the sensing tube comprises receiving the transmitted electrical signal by a second sensor connected to the second part of the sensing tube.

14. The method of claim 13, wherein the first part of the sensing tube comprises a first end of the sensing tube, and the second part of the sensing tube comprises a second end of the sensing tube.

15. The method of claim 11, wherein the electrical signal comprises a diagnostic pulse, a half sine or square wave form generated at a specific interval, or a series of square wave pulses.

16. The method of claim 11, wherein the determining differences between the transmitted electrical signal and the received signal comprises determining a difference in at least one from among a voltage, a current, and a frequency, of the transmitted electrical signal and the received signal.

17. The method of claim 11, wherein the diagnosing the condition of the sensing tube based on the determined differences comprises diagnosing a defect in the sensing tube based on the determined difference.

18. The method of claim 17, wherein the diagnosing the defect in the sensing tube based on the determined difference comprises diagnosing a size of the defect.

19. The method of claim 18, wherein the defect comprises at least one from among a puncture in the sensing tube, a hole in the sensing tube, a severed sensing tube, a crack in the sensing tube and a degradation in wall of the sensing tube.

20. A sensing tube diagnostic apparatus, comprising:
a sensor configured to transmit an electrical signal at a first part of a sensing tube and receive the transmitted signal at a second part of the sensing tube; and
a controller configured to determine a difference between the transmitted electrical signal and the received signal, and diagnose a condition of the sensing tube based on the determined difference.
